(19) United States
(12) Patent Application Publication
(10) Pub. No.: US 2007/0116227 A1
(43) Pub. Date: May 24, 2007

(54) System and method for advertising to telephony end-users

(76) Inventors: Mikhael Vitenson, Rowayton, CT (US); Blair Wallace, Brooklyn, NY (US)

Correspondence Address: MINTZ LEVIN COHN FERRIS GLOVSKY & POPEO, 666 THIRD AVENUE, NEW YORK, NY, 10017, US

(21) Appl. No.: 11/248,889

(22) Filed: Oct. 11, 2005

(51) Int. Cl. H04M 3/42

(52) U.S. Cl. 379/207.02

(57) ABSTRACT

Systems and methods are provided for advertising to telephony end-users. The ads delivered via these systems and methods can be targeted to the personal interests and/or other characteristics of the telephony end-users. Alternatively or additionally, the telephony end-users can be provided with interactive functionality with respect to the ads. The ads may be delivered, for example, during various phases of a telephone call.

### FIELD OF THE INVENTION

Embodiments of the present invention relate to systems and methods for advertising to consumers and, more particularly, to systems and methods for advertising to telephony end-users.

### BACKGROUND OF THE INVENTION

Traditionally, business establishments have advertised their respective goods and services to consumers through the use of various approaches including, for example, distributing ads via radio, television, billboards, physical mail, and the Internet, and using telemarketers to call the telephones of consumers. Increasingly, consumers are ignoring the ads provided via these approaches and/or utilizing ways to avoid the ads altogether. For example, consumers often change a radio or television channel to avoid advertisements since alternative programming without the ads is typically readily available on other channels (e.g., other “preset” or “favorite” channels). Consumers also use various computer-implemented tools such as pop-up blockers to block advertisements on the Internet and suitable television equipment (e.g., a digital video recorder (DVR)) to fast forward through commercials during playback of recorded television programs. As another example, telephony end-users place their telephone numbers on do-not-call lists to prevent calls from telemarketers, or avoid a telemarketer's call after noticing the “caller ID”. This desire by consumers to avoid advertisements may be due, at least in part, to the notion that ads delivered by these traditional approaches may be unlikely to correlate with the personal interests and/or other characteristics of the consumers. Additionally, the extensive use of these traditional approaches for advertising may have reduced their effectiveness.

In view of the foregoing, it would be desirable to provide new approaches for advertising to consumers, in which the advertisements are likely to correlate with the personal interests and/or other characteristics of the consumers.

### SUMMARY OF THE INVENTION

Embodiments of the present invention relate to systems and methods for advertising to telephony end-users, who communicate to or receive communication from any telephony equipment currently in use and any successor telephony equipment. Advertisements, which may be audio, video, text, image, etc., or a combination thereof (“ads”), delivered via these systems and methods can be targeted to the personal interests and/or other characteristics of the telephony end-users. Alternatively or additionally, the telephony end-users can be provided with interactive functionality with respect to the ads. The systems and methods of the present invention can be implemented through the use of any suitable hardware and/or software configured to communicate within one or more telephone networks such as, for example, the Public Switched Telephone Network (PSTN, sometimes referred to as Plain Old Telephone Service (POTS)), a mobile telephone network, a Voice-over-Internet-Protocol (VoIP) network, a Private Branch eXchange (PBX) network, any other suitable telephone network, their successor network(s), and/or any suitable combination of telephone networks. Illustrative features provided by the systems and methods of the present invention are summarized below. While these features are summarized primarily in terms of individual embodiments, any and all combinations of these embodiments are contemplated by the present invention. For example, representative combinations of these and other features of the present invention are described in the Detailed Description of the Invention.

In an aspect, systems and methods are provided for targeting advertisements to telephony end-users. For example, in one embodiment, a voice recognition module is provided that extracts contextual data from the telephone conversations of end-users. The voice recognition module may, for example, compare the voicestream of one or more of the callers (e.g., two callers) to a library of spoken words with known meaning. The data extracted by the voice recognition module can be used alone or in combination with other data (e.g., time and/or date of call, caller demographics, and/or other caller characteristics such as caller telephone number(s), location(s) and/or other information such as location temperature, and service provider(s)) to select an appropriate one or more advertisements for delivery to user telephone equipment via a suitable one or more delivery approaches. As used herein, a “delivery approach” includes any way of delivering an advertisement that can be described by one or more delivery criteria including, for example, the multimedia content of the advertisement (e.g., audio, image, video and/or text), the recipient(s) of the advertisement, the means used to deliver and/or present the advertisement to the recipient(s), and/or the circumstances such as the timeframe in which the advertisement is delivered. Delivery of ad(s) to user telephone equipment can precede the presentation of the ads to end-users by any suitable time period (e.g., presentation occurring immediately upon or shortly after the delivery or the ad(s) being stored in memory of user equipment upon delivery and activated at a subsequent time for presentation). The extracted data and/or data regarding the advertisements delivered to telephony end-user(s) may be stored in, for example, profile(s) for the end-user(s) that can be referenced and/or modified (e.g., updated) in the future and/or used for the targeting of future ads (e.g., selling profile data to third parties for use in targeting ads via the physical mail). For example, based on data from the profile for an end-user indicating the number of ads accepted by the end-user or based on the end-user's agreement to accept ads (e.g., the end-user's telephone service agreement), a telephone service provider may adjust the end-user's billing statement for the telephone service. This provides end-users with a direct incentive to receiving telephony ads.

In another embodiment related to targeting advertisements to telephony end-users, systems and methods are provided for extracting call data (e.g., the above-described data extracted by a voice recognition module and/or other call data such as caller demographics) regarding three or more callers during a single telephone call (e.g., a three-way conference call). The extracted call data is then used to select an appropriate one or more advertisements for delivery to user telephone equipment via one or more delivery approaches. The extracted call data may be further processed such as stored in, for example, profile(s) for the caller(s) for future use.

In another aspect, systems and methods are provided for advertising to telephony end-users in which the ad(s) are initiated (e.g., delivered and/or presented) to the end-users during various timeframes. For example, in one embodiment, advertisements are initiated to telephony end-user(s) whose call with another caller (e.g., a wireless or VoIP caller) is terminated due to signal loss. The telephony end-user(s) may be permitted to “hold-the-line” in that the end-user(s) are presented with advertisement(s) until the other caller re-joins the call, at which time the ad(s) may be discontinued.

In another embodiment, systems and methods are provided that initiate advertisement(s) to telephony end-user(s) during a timeframe traditionally occupied (at least in part) by a dial-tone. The ad(s) may be delivered to the end-user(s) in place of, or in addition to (e.g., superimposed upon), the dial tone. For example, when a user of a land-line or VoIP-enabled telephone takes the telephone off-hook, one or more ads may be delivered to the user until, for example, the user begins to dial or completes the dialing of a telephone number. In another example, the ad(s) may be delivered and/or presented to the end-user from the time the user takes the telephone off-hook until a called party answers the call.

In still another embodiment, systems and methods are provided that initiate advertisements (e.g., image, video and/or text advertisements) for display on telephones with suitable displays (e.g., cell phones with displays, videophones, and any other telephones having suitable display equipment) such as, for example, immediately upon completion of a telephone call or at any other suitable time such as prior to or during the call. For example, an image advertisement may be delivered to a telephone and, subsequent to the delivery, the image may be set as wallpaper (e.g., automatically or in response to an end-user responding affirmatively to a prompt such as a pop-up on a display or audible prompt) or otherwise displayed on the telephone's display. As another example, a text advertisement may be delivered to a telephone and displayed by the telephone in, for example, a caller-ID display field (e.g., in an alternating fashion with conventional caller ID information such as caller names and telephone numbers) or in a banner area in the display (e.g., a mobile phone banner area traditionally customizable by an end-user to read, for example, “My Mobile Phone” or to include any other combination of text and/or symbols).

In yet another embodiment, systems and methods are provided that initiate advertisement(s) during the ringing period of a telephone call by replacing the ring tone of the called party (i.e., in contrast to the ringback signal of the calling party) with an advertisement(s) such as an audible jingle for a telephone service provider or other entity. For example, in advance of a telephone call, one or more ring tones may be pushed to the end-user's telephone (e.g., a mobile telephone) for storage by the telephone (i.e., in contrast to the ring tones being selected and downloaded by the end-user, such as in response to a user scrolling through a list of available ring tones). Then, immediately prior to the ringing period of the telephone call, a signal may be transmitted to the end-user's telephone that causes a selected one of the ring tone(s) to be presented during the ringing period. As another example, a ring tone may be pushed to the end-user's telephone and set automatically as the ring tone presented to the end-user when an incoming call is received (e.g., the ring tone remaining set for a given time period such as a week or until another ring tone is pushed to the end-user's telephone). In still another example, the ring tone may be streamed in real time to the end-user's telephone during the ringing period.

In another embodiment, systems and methods are provided that initiate advertisements to telephony end-user(s) during call hold times, such as when a caller is placed on hold during 3-way call setup by another caller and/or when another caller answers call waiting. In each of these embodiments related to initiating ads to telephony end-users, the ads may be initiated by a party other than the parties to a telephone call (where the parties to the telephone call include the end-users involved in the telephone call as well as their associated employers and/or other entities to which the telephone service is registered, when the end-users are using telephones of their employers or the other entities). To illustrate this point, for a telephone call involving a first caller using an employer's telephone and a second caller using that caller's own telephone line, the ads may be initiated by an application under the primary control of a party other than the first caller, the first caller's employer, and the second caller. For example, a telephone advertising application may be provided that is controlled at least primarily by the other party. The application is said to be under the complete control of the other party when, for example, the parties to the telephone call have no control over the ads initiated (e.g., selected, delivered, and/or presented) by the application. The application is said to be under the primary control of the other party when, although the other party performs the majority of functions with respect to the ads such as selecting, delivering, and/or presenting ads to callers, the parties to the telephone call can perform minor functions such as setting preferences (e.g., selecting desired ad types and/or time intervals in which ads will be transmitted).

In another aspect, systems and methods are provided that enable telephony end-users to interact with telephony advertisements. For example, an end-user may be provided with an option (e.g., an audible or visual prompt) to hear or view an advertisement in its entirety. Such an option may be exercised by the end-user in order to hear or view an ad that ended prematurely (e.g., midstream) the last time it was presented to the end-user, an ad that the end-user believes will end prematurely (e.g., due to the possibility that another caller such as a caller who initiated 3-way call setup will rejoin the call prior to completion of the ad, thus causing the ad to end prematurely), and/or an ad that the user may have otherwise missed a portion of when the ad was first presented (e.g., because the user was distracted and/or due to ambient noise such as passing automobile traffic). As another example, a telephony end-user may be presented initially with a shortened ad (e.g., 4-second ad) and the user may be provided with an option to request that a more detailed version of the ad (e.g., 30-second ad). In these examples, the telephony end-user may exercise the option by, for example, pressing on a telephone keypad or speaking “2*” during or after the time that the ad is presented in the first instance to the end-user. The ad may be delivered and/or presented to the end-user at suitable time(s) such as during a hold time or upon completion of the call via a follow-on communication (e.g., the end-user's telephone ringing after the user places the phone on-hook, and the ad being presented to the user upon answering the call).

### BRIEF DESCRIPTION OF THE DRAWINGS

For a better understanding of the present invention, reference is made to the following description, taken in conjunction with the accompanying drawings, in which like reference characters refer to like parts throughout, and in which:

FIG. 1A is a diagram of a system for advertising to telephony end-users in accordance with an embodiment of the present invention;

FIG. 1B is a diagram of a system for advertising to telephony end-users in accordance with another embodiment of the present invention;

FIG. 2 is a flowchart of illustrative stages involved in advertising to telephony end-users in accordance with an embodiment of the present invention;

FIGS. 3 and 4 are flowcharts of illustrative substages involved in selecting a delivery approach for use in delivering advertisement(s) to user telephone equipment in accordance with various embodiments of the present invention;

FIG. 5 is a flowchart of illustrative substages involved in selecting an advertisement based on the personal interests and/or other characteristics of telephony end-user(s) in accordance with an embodiment of the present invention;

FIG. 6 is a flowchart of illustrative substages involved in providing a telephony end-user with interactive functionality with respect to an ad in accordance with an embodiment of the present invention; and

FIGS. 7A-7C show data that may be generated and/or utilized by a telephone advertising application in connection with providing advertising features to telephony end-users in accordance with various embodiments of the present invention.

### DETAILED DESCRIPTION OF THE INVENTION

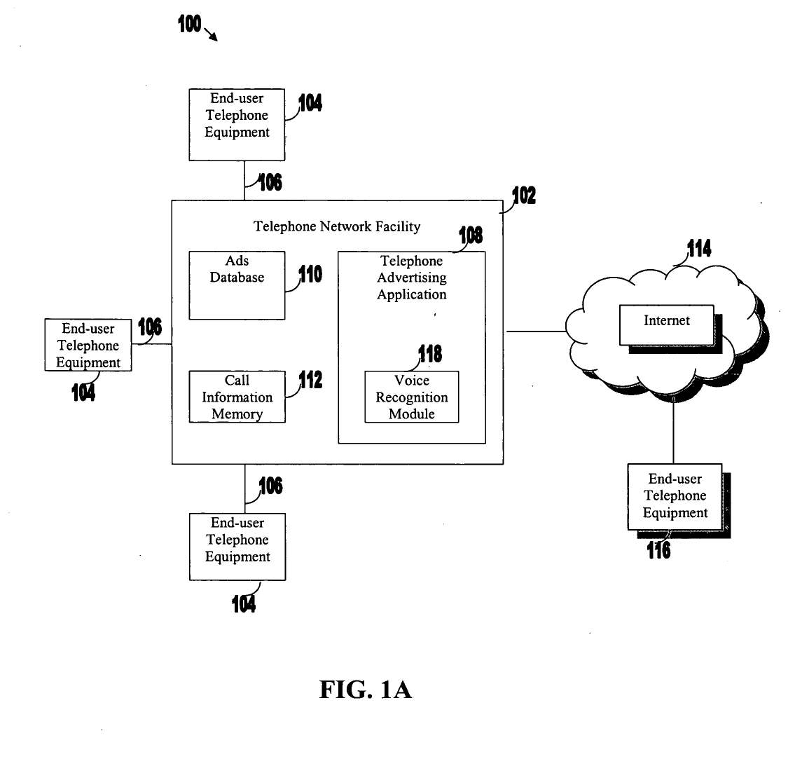

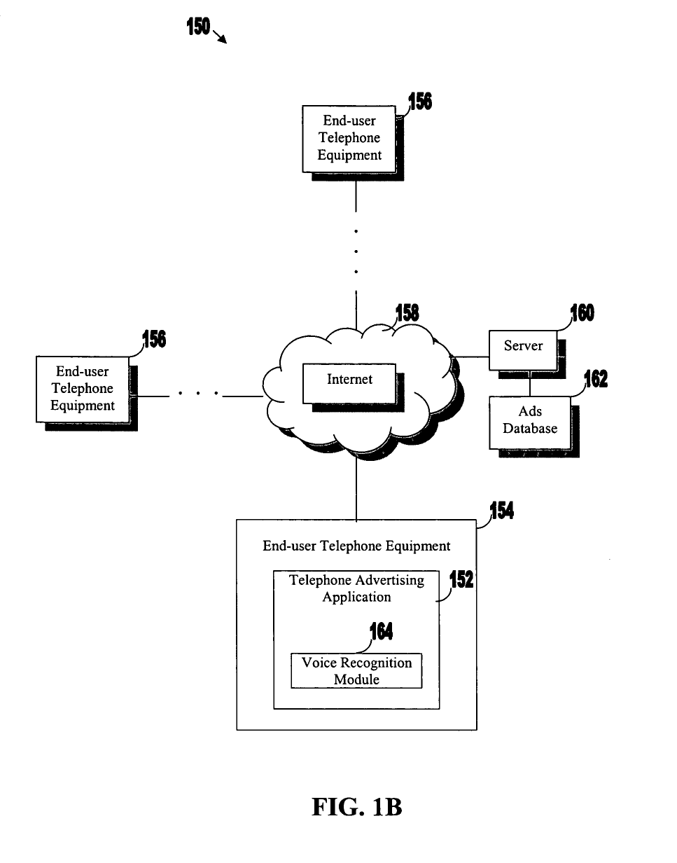

FIG. 1A is a diagram of a system 100 for advertising to telephony end-users in accordance with an embodiment of the present invention. System 100 includes telephone network facility 102 that communicates with end-user telephone equipment 104 via communications capabilities 106. Telephone network facility 102 includes telephone advertising application 108, advertisements database 110, and call information memory 112. For example, telephone network facility 102 may be a local telephone office within the Public Switched Telephone Network (PSTN, sometimes referred to as Plain Old Telephone Service (POTS)) and may communicate with land-line telephones 104 via copper wire and/or fiber optic cable 106. As another example, telephone network facility 102 may be a Mobile Telephone Switching Office (MTSO) within a mobile communications network and may communicate with mobile telephones 104 via wireless connections 106. Still another example, telephone network facility 102 may be an Internet Service Provider (ISP) or other facility having access to Internet 114 that uses Voice-over-Internet-Protocol (VoIP) technology to communicate with VoIP-enabled telephones (104, 116; e.g., desktop computers having microphones). Communications capabilities 106 may be copper or fiber optic telephone lines (e.g., for connection to ISP 102 via dial-up), cable connection(s), satellite connection(s), Direct Subscriber Lines (DSLs), any other suitable connection(s) to ISP 102, or a combination thereof. In yet another example, telephone network facility 102 may be a facility within a Private Branch eXchange (PBX) network (e.g., a PBX implemented by a private business establishment) and may communicate with telephones 104 internal to the PBX network via a suitable communications capability 106 (e.g., a local area network (LAN) when the PBX network is an Internet Protocol (IP) PBX).

Telephone network facility 102 may enable the various installations of end-user telephone equipment 104 to communicate with one another. Facility 102 also may enable user telephone equipment 104 to communicate with user telephone equipment associated with other telephone networks. To that end, multiple telephone network facilities 102 may be included in system 100, however only a single telephone network facility 102 is shown in FIG. 1A to avoid overcomplicating the drawing. For example, when facility 102 is a local office of the PSTN, facility 102 may communicate with other PSTN local office(s) in order to enable communication between their respective land-line telephones. As another example, a PSTN local office 102 may communicate with an MTSO in order to enable communication between land-line and mobile telephones. Still another example, a PBX facility 102 may communicate with another one or more telephone network facilities (e.g., a PSTN local office and/or an ISP) to enable telephone equipment internal to the PBX network to communicate with telephone equipment external to the PBX network. Generally, user telephone equipment of any type(s) (e.g., land-line, mobile, and/or VoIP-enabled telephones) and/or geographic location(s) can be placed in communication with one another by enabling communication between their respective telephone network facilities. Communication between telephone network facilities may be accomplished via one or more networks, switches, gateways, through intermediate facilit(ies), or a combination thereof.

Telephone advertising application 108 may include any hardware (e.g., one or more processors), software or combination thereof operative to implement the features of the present invention related to advertising to telephony end-users. For example, application 108 may include suitable processing equipment and/or instructions stored in memory and executable by a processor for, for example, selecting suitable delivery approach(es) for delivering ads to telephony end-users (e.g., selecting to deliver ads during one or more timeframes), selecting ad(s) from database 110 for delivery to telephony end-users based on data indicating the personal interests and/or other characteristics of the end-users, and/or providing telephony end-users with interactive functionality with respect to the ads.

Telephone advertising application 108 may select suitable delivery approach(es) based on data stored in memory 112 or other memory such as call status data (e.g., on-hook, off-hook, dialing status, ringing status, busy status, call answer status, hold status such as call waiting hold and 3-way call setup hold, and signal loss status). Alternatively or additionally, data such as time and/or date of call, caller telephone number(s), location(s), service provider(s), and cell phone capabilities may be used to select the delivery approaches. For example, telephone advertising application 108 may deliver ad(s) to user telephone equipment 104 during a timeframe traditionally occupied (at least in part) by a dial-tone when application 108 detects data in memory 112 indicating that equipment 104 is off-hook and data indicating that the end-user associated with equipment 104 has yet to initiate a dialing sequence. User telephone equipment is off-hook when, for example, an end-user associated with the telephone equipment lifts the telephone off its receiver or takes some similar action that traditionally activates the dial-tone such as pressing a hands-free button on the telephone. As another example, application 108 may transmit video and image ads to end-user equipment 104 when memory 112 or other memory includes data indicating that equipment 104 includes a suitable display device (e.g., a model number of equipment 104 from which the equipment capabilities can be determined). Additional details regarding selecting delivery approaches by a telephone advertising application are described below.

With respect to targeting ads to telephony end-users, telephone advertising application 108 may include voice recognition module 118 operative to extract contextual data from telephone conversations of end-users. In another embodiment, voice recognition module 118 may be a stand-alone application operative to interface with application 108 (e.g., with functions related to extracting data performed by module 118 and functions related to selecting ad(s) based on the data performed by application 108). Voice recognition module 118 may include any suitable software, hardware, or combination thereof. For example, voice recognition module 118 may compare the voicestream(s) associated with equipment 104 and/or other user telephone equipment (e.g., end-user telephone equipment 116) to a library of spoken words with known meaning. The data extracted by module 118 may be analyzed to determine, for example, the words used most frequently in the conversation. Telephone advertising application 108 may select an advertisement from database 110 for delivery to user telephone equipment based on the data extracted by voice recognition module 118 (e.g., all recognized words or the words most frequently used during the conversation) and/or other data (e.g., time and/or date of call, caller telephone number(s), location(s), service provider(s), and/or other data such as end-user profile(s) that include demographic data and/or data regarding user preferences). For example, the advertisements stored in database 110 may have various keywords associated therewith for comparison to the data extracted by voice recognition module 118 and/or other call or demographic data. In other embodiments, database 110 may be located remotely from facility 102, such as in the location of a server accessible by facility 102 via Internet 114. Facility 102 may transmit requests including the data extracted by voice recognition module 118 and/or other data to the server, which may return ad(s) that match the requests to facility 102. Additional details regarding targeting ads to telephony end-users by a telephone advertising application are described below.

With respect to providing end-users with interactive functionality related to telephony ads, telephone advertising application 108 may monitor communication from an end-user subsequent to the delivery of ad(s) to the end-user, thereby enabling application 108 to provide the end-user with additional features and/or services related to the ads. For example, upon delivering an advertisement to an end-user (e.g., during a call hold time), telephone advertising application 108 may monitor whether the end-user presses on a telephone keypad or speaks “2*” (e.g., such speech detected by voice recognition module 118). In response to detecting this end-user selection, application 108 may re-deliver the advertisement to the user or deliver a supplemental advertisement to the user at a suitable time (e.g., immediately, upon completion of a current telephone call, or during a subsequent hold time). Additional details regarding providing end-users with interactive functionality related to telephony ads are described below.

The advertising features provided to a given telephony end-user may be based, at least in part, on the way that the end-user's telephone equipment communicates with telephone advertising application 108 within system 100. For example, because user telephone equipment 104 communicates with telephone network facility 102 (and therefore telephone advertising application 108) for both incoming and outgoing calls, telephone advertising application 108 may provide user telephone equipment 104 with advertising features for all incoming and outgoing calls and/or at other times (e.g., times unrelated to a telephone call such as during halftime of the NFL Super Bowl). In contrast, telephone advertising application 108 may provide user telephone equipment that communicates only occasionally with facility 102 with advertising features on such occasions and/or at other times (e.g., providing user equipment 116 with advertising features only when equipment 116 initiates a call to, or receives a call from, user equipment 104).

Multiple telephone advertising applications may be included in system 100 such as, for example, one per telephone network facility. These telephone advertising applications may be operative to cooperate with one another (e.g., share resources such as demographic information from end-user profiles), or operate independently of one another, in order to advertise to telephony end-users. For example, when user equipment 116 communicates with end-user equipment 104 through Internet 114 and facility 102, communications to and from user equipment 116 may pass through an ISP (not shown) that includes a separate telephone advertising application. In this context, the ISP (and its associated advertising application) may be referred to as the “home” application of end-user equipment 116, and facility 102 with its associated application 108 may be referred to as the home application of end-user equipment 104. In various embodiments, some advertising features may be provided to an end-user by an end-user's home application, whereas other advertising features may be provided to the end-user by advertising application(s) other than the end-user's home application. For example, dial-tone advertising may be provided by the home application only, because no telephone advertising application other than the end-user's home application may be capable of communicating with the end-user's telephone equipment prior to the end-user initiating an outgoing telephone call. As another example, a protocol may be established that defines how multiple telephone advertising applications will divide advertising opportunities when, for example, end-users associated with different advertising applications are parties to the same telephone call. To illustrate this point, a rule may be established (e.g., stored as processing instructions in memory) that, when a first caller places a second caller on hold to answer call waiting, the home advertising application of the first caller (and not the advertising application associated with the second caller) has the right-of-way to advertise during the hold time.

FIG. 1B is a diagram of a system 150 for advertising to telephony end-users in accordance with another embodiment of the present invention, in which telephone advertising application 152 running on end-user telephone equipment 154 provides advertising features to telephony end-user(s) (e.g., the end-users associated with equipment 154 and/or other user telephone equipment such as equipment 156). In other embodiments of the present invention, a telephone advertising application may be implemented in a distributed arrangement by a telephone network facility and user telephone equipment (e.g., with functions related to selecting and delivering ads implemented at the network facility and functions related to presenting the ads to the end-user implemented by the user equipment) or as part of a facility that either facilitates communications between one or more telephone network facilities and/or user telephone equipment (i.e., an intermediate facility) or that otherwise has access to call information (e.g., call status information and/or voicestream(s) of the caller(s)).

Returning to FIG. 1B, system 150 is another example of a VoIP network in which the voicestreams associated with end-user telephone equipment 154 and 156 are transmitted over Internet 158 as IP packets. End-user equipment 154 may be, for example, a desktop computer having a microphone and a monitor, and advertising application 152 installed thereon (e.g., application 152 resident in memory at the time of purchase of equipment 154 by the end-user, downloaded from Internet 158, or installed by way of a CD-ROM or other computer-readable media). Alternatively or additionally to being provided with advertising features by telephone advertising application 152, telephone advertising application(s) associated with one or more installations of user telephone equipment 156 may provide end-user equipment 154 and/or 156 with advertising features. For example, equipment 156 may have the same telephone advertising application version installed thereon as equipment 154. As another example, equipment 156 may be associated with a telephone advertising application located in a network facility, in the same way that user telephone equipment 104 in FIG. 1A is associated with application 108 located in facility 102.

Telephone advertising application 152 may select ads for delivery to user telephone equipment by, for example, submitting a request to server 160 for an ad from database 162. The request may include one or more criteria regarding the ad, such as keyword data extracted by voice recognition module 164 from the voicestream(s) of one or more callers and/or other data (e.g., caller telephone number(s), location(s), date and time of call, end-user telephone capabilities, end-user demographic data and/or preferences). As shown, voice recognition module 164 may be running on user equipment 154 (as opposed to within a telephone network facility or other facility). Voice recognition module 164 may operate in substantially the same way as voice recognition module 118 in FIG. 1A and therefore will not be further described. Ad(s) may be delivered to the end-users using any suitable delivery approach(es) such as timeframes selected based on, for example, the detection by application 152 of various call status information (e.g., off-hook, on hold for 3-way call setup or call waiting, or signal loss). Telephone advertising application 152 may also provide end-users of equipment 154 and 156 with interactive functionality with respect to the ads.

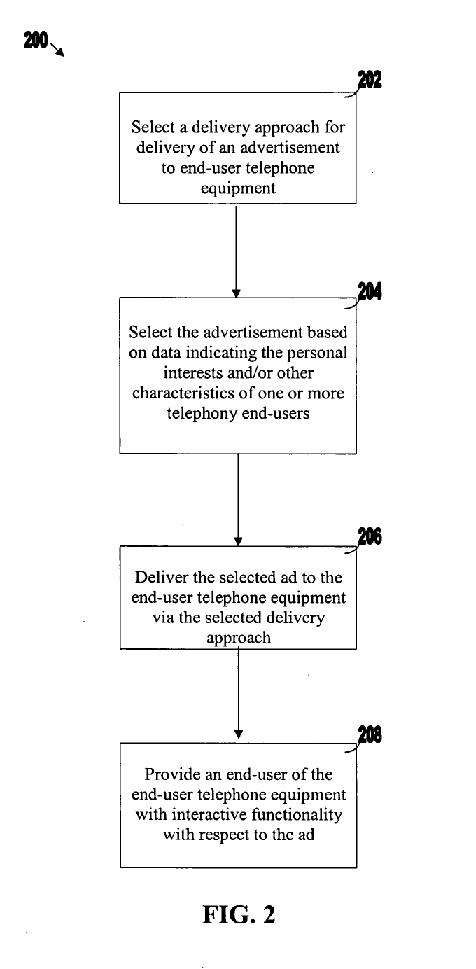

FIG. 2 is a flowchart 200 of illustrative stages involved in advertising to telephony end-users in accordance with an embodiment of the present invention. Flowchart 200 combines features of the invention related to selecting a delivery approach for delivery of an ad to user telephone equipment (stage 202), selecting the ad to be delivered based on data indicating the personal interests and/or other characteristics of one or more telephony end-users (stage 204), delivering the selected ad to the user telephone equipment via the selected delivery approach (stage 206), and providing an end-user of the user telephone equipment with interactive functionality with respect to the ad (stage 208). In some embodiments, a subset of stages 202-208 may be optional stages. For example, stages 204 and 208 may be optional when stage 202 of selecting a delivery approach involves selecting to deliver ad(s) to the user equipment (a) during a time interval traditionally occupied by a dial-tone, where the timeframe in which the ad(s) are delivered can be shorter, longer, or substantially the same length as the timeframe traditionally occupied by the dial-tone, (b) when a caller is placed on hold so that another caller can (i) answer call waiting or (ii) initiate a 3-way call, (c) when a caller is disconnected from a call due to signal loss, or (d) during a ringing period by replacing the ring tone of the called party. As another example, stage 208 may be optional when stage 204 of selecting an ad involves selecting the ad based on data extracted by a voice recognition module from a telephone conversation between telephony end-users. Still another example, stage 304 may be optional when stage 308 of providing interactive functionality involves providing an end-user with an option to be presented with an ad previously presented (in whole or in part) to the end-user or an ad that supplements a previously presented ad (e.g., an option to be presented with the ad in response to pressing on a keypad or speaking “2*”).

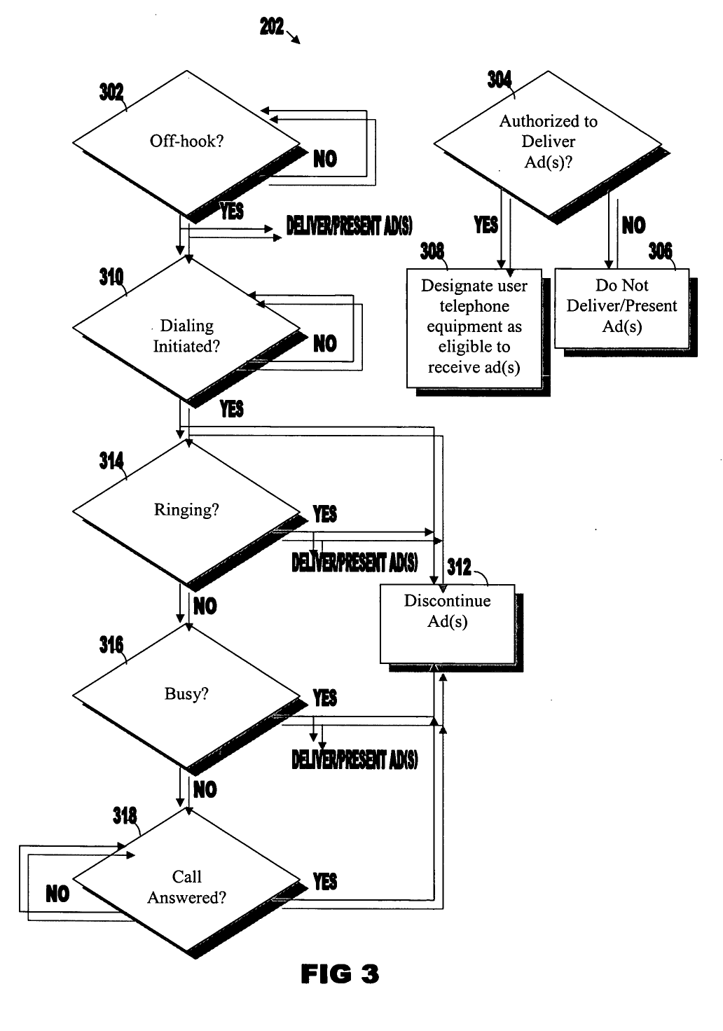

FIG. 3 is a flowchart of illustrative substages involved in stage 202 (FIG. 2) of selecting a delivery approach for delivery of advertisement(s) to user telephone equipment in accordance with various embodiments of the present invention. The embodiments of FIG. 3 relate primarily to delivering and/or presenting ad(s) to user telephone equipment during timeframe(s) that precede successful connection of the user telephone equipment with the equipment of other telephony end-user(s). At stage 302, a telephone advertising application may determine whether user telephone equipment is off-hook. The telephone advertising application may repeat stage 302 when user telephone equipment is not off-hook (and/or may repeat stage 302 continuously in order to determine whether any of a plurality of installations of user telephone equipment is or becomes off-hook). When user telephone equipment is off-hook (e.g., when an end-user has taken a land-line telephone off its receiver), the telephone advertising application may initiate the delivery and/or presentation of advertising to the user equipment during a timeframe traditionally occupied at least in part by a dial-tone but, for example, only if it is determined at stage 304 that the telephone advertising application is authorized to advertise to the user equipment. For example, at stage 304 an application such as application 108 may determine whether the user telephone equipment is listed on a do-not-call list and/or whether an end-user of the user telephone equipment or a provider of the end-user's telephone service has entered into an agreement with a provider of the telephony advertising application that provides such authorization. If no such authorization has been provided, no advertisement may be delivered as reflected by stage 306. The telephone advertising application may then ignore all other opportunities for delivering ads to the user equipment, or may advertise to the user equipment during other intervals (e.g., call hold times) in which the advertising application has the requisite authorization (e.g., as determined based on preferences in a profile associated with the user equipment). If the telephone advertising application has the requisite authorization, at stage 308 the telephone advertising application may designate the user equipment as eligible to receive telephony ad(s) (e.g., ads of all types or dial-tone ads only). The telephone advertising application may also determine other characteristics regarding the delivery approach (e.g., multimedia content of the ad(s) and/or recipient(s) of the ad(s)) at stage 308.

The telephone advertising application may continue to monitor the status of user equipment to, for example, determine a suitable time at which the dial-tone ad(s) initiated as a result of stage 302 should be discontinued and/or to determine other suitable timeframe(s) for the delivery and/or presentation of ads (e.g., other timeframes such as the ringing period of a telephone call and/or during the time period that a called party's telephone is busy). For example, at stage 310, the telephone advertising application may determine whether an end-user of user telephone equipment has initiated a dialing sequence. The telephone advertising application may repeat stage 310 when no dialing sequence has been initiated, which may allow advertising initiated as a result of stage 302 to continue. When a dialing sequence is initiated by the end-user, at stage 312 the telephone advertising application may discontinue delivery and/or presentation of the ad(s) delivered and/or presented to the user equipment as a result of stage 302.

The telephone advertising application may determine at stage 314 whether a telephone call involving user telephone equipment has progressed to the ringing period. The telephone advertising application may proceed to stage 316 when the ringing period has not been reached. When the ringing period is reached, the telephone advertising application may, for example, discontinue at stage 312 the ad(s) delivered and/or presented to the user equipment as a result of stage 302 (as an alternative to discontinuing the dial-tone advertising upon the end-user initiating a dialing sequence) and/or initiate the delivery and/or presentation of advertising during the ringing period by, for example, proceeding to stage 304. In one embodiment, the telephone advertising application may provide a called party with ad(s) in place of, superimposed on, or between successive ringback signals (i.e., the simulated ringing sound heard by calling parties indicating that the called party's telephone is ringing). In another embodiment, the telephone advertising application may replace the ring tone of the called party (e.g., a called party using a mobile telephone) with an advertisement such as an audible jingle associated with a telephone service provider or other entity. The telephone advertising application may proceed to stage 318 when the ringing period is reached.

The telephone advertising application may determine at stage 316 whether the call status of a telephone call is “busy.” The telephone advertising application may proceed to stage 318 or return to stage 314 when the answer is in the negative. When the call status is busy, the telephone advertising application may, for example, discontinue at stage 312 delivery and/or presentation of the ad(s) delivered and/or presented as a result of stage 302 to user equipment participating in the telephone call (as yet another alternative to determining an end time for dial-tone ad(s)). Alternatively or additionally, the telephone advertising application may initiate advertising to the user equipment during the busy signal period by, for example, proceeding to stage 304. For example, the telephone advertising application may interrupt the dial-tone advertising with a message stating that the called party's telephone line is busy, that telephone advertising will continue during the busy signal period, and/or that the user equipment will be connected to the called party when the called party's telephone line becomes available provided that the end-user stays on the line.

The telephone advertising application may determine at stage 318 whether a telephone call has been answered by a called party. The telephone advertising application may repeat stage 318 or may return to stage 314 or 316 when the call has not been answered. When the call is answered (i.e., the parties are connected successfully), the telephone advertising application may discontinue at stage 312 delivery and/or presentation of the ad(s) delivered and/or presented to the user equipment as a result of stage 302 (as another alternative to an end time for dial-tone ad(s)), stage 314 (i.e., ringing period ads), or stage 316 (i.e., busy signal ads).

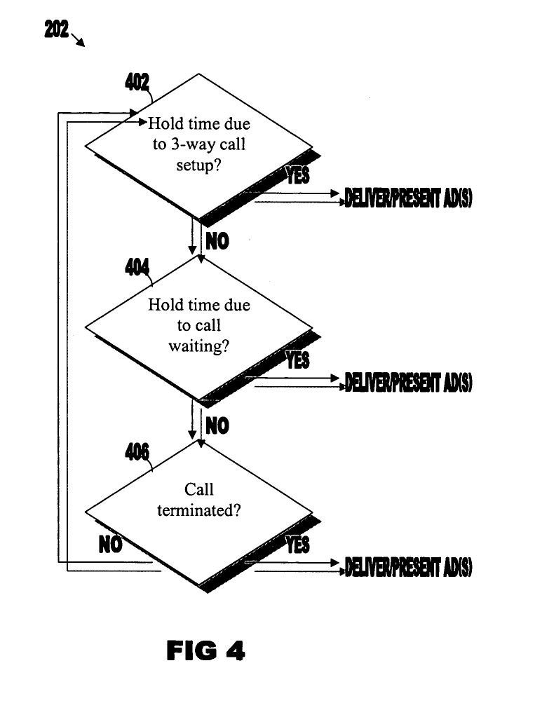

FIG. 4 is a flowchart of illustrative substages involved in stage 202 (FIG. 2) of selecting a delivery approach for delivery of advertisement(s) to user telephone equipment in accordance with various embodiments of the present invention. The embodiments of FIG. 4 relate primarily to delivering and/or presenting advertisement(s) to user telephone equipment during timeframe(s) subsequent to successful connection of the user telephone equipment with the equipment of other telephony end-user(s). The telephone advertising application may determine at stage 402 whether one or more part(ies) have been placed on hold to allow another party to set up a 3-way call. The telephone advertising application may proceed to stage 404 when the answer is in the negative. When the part(ies) have been placed on hold for 3-way call setup, the telephone advertising application may, for example, initiate advertising to the part(ies) by, for example, proceeding to stage 304 (FIG. 3). Such advertising may be provided until, for example, the party who initiated the 3-way call rejoins the telephone call. When multiple parties are on hold, stage 304 may involve determining whether the telephone advertising application is authorized to advertise to the multiple parties. If any one (e.g., all) of the parties has refused advertising (or has not affirmatively authorized advertising), no advertising may be provided to the end-users as reflected by stage 306. Alternatively, advertising may be provided to one or more callers (e.g., all callers) when advertising is authorized for one or more of the callers (e.g. a majority of the callers).

The telephone advertising application may determine at stage 404 whether one or more part(ies) have been placed on hold to allow another party to answer call waiting. The telephone advertising application may proceed to stage 406 when the answer is in the negative. When the part(ies) have been placed on hold for call waiting, the telephone advertising application may initiate advertising to the part(ies) (e.g., via stage 304 (FIG. 3)) using, for example, the illustrative rules that govern advertising to multiple parties described above in connection with stage 404. Such advertising may be provided until, for example, the party who answered call waiting rejoins the telephone call. In other embodiments, ads may be initiated during hold times that result from the interaction of telephony end-users with automated systems. For example, the telephone advertising application (or facility or device in communication with the application) may receive call status data from an automated system indicating that a telephony end-user is on hold. In response, the application may initiate advertising to the user. Examples of such automated systems are a system associated with a calling card provider that places an end-user on hold while the provider verifies the card information, a system associated with a conference call provider that places end-user(s) on hold while waiting for the call leader or other callers to join the conference, a system associated with a provider of a “find me, follow me” service for locating a caller, and a system associated with a voicemail provider that places an end-user on hold during message retrieval or between messages.

The telephone advertising application may determine at stage 406 whether the telephone call has been terminated (e.g., which may be said to occur when all or a subset of the parties to the telephone call hang up their telephones). The telephone advertising application may return to stage 402 when the answer is in the negative. When the telephone call is terminated, the telephone advertising application may initiate advertising to the part(ies) by proceeding to stage 304 (FIG. 3). For example, the telephone advertising application may deliver text, image, audio, or video ads to user telephone equipment immediately after the call or at another suitable time period. In the example of delivering image ads, the ads may be set automatically as wallpaper on the end-user's telephone (e.g., as a result of the ads being accompanied by control data instructing the user's telephone or an advertising application running thereon to set the ad as wallpaper).

The call status data described in connection with FIGS. 3 and 4 may be generated by existing telephone network(s) and/or successor telephone network(s) as a result of normal call setup and/or call termination procedures, and transmitted to the telephone advertising application (e.g., accessed by the telephone advertising application from memory 112 (FIG. 1A) or other memory such as memory of end-user telephone equipment 154 (FIG. 1B)). For example, existing telephone systems use a variety of signaling protocols to establish telephone calls across telephone lines owned by different entities. One of these protocols, Feature Group D (FG-D), defines interconnection rules between a local exchange carrier (LEC) and an inter-exchange carrier (IEC or long-distance carrier). FG-D services route inter-LATA calls to the IEC point of termination, route calls with a carrier access code to the user's carrier, and pass information to the carrier. The information passed includes an automatic number identification (ANI), identifying the caller's telephone number. Unlike FG-D, more advanced signaling systems have a signaling channel separate from a group of voice channels associated therewith. This “out-of-band” signaling channel may transmit a multitude of information for each voice channel that was not transmitted using FG-D, such as the identity of the switch from which a call originates. One such advanced signaling system is “SS7” (Signaling System 7), which may also be referred to as “C7,” “Common Channel Signaling System No. 7,” or “CCSS7.” SS7 is a global standard for telecommunications defined by the International Telecommunication Union that can be used to make features such as call waiting, three-way calling and caller ID possible. The standard defines the procedures and protocol by which network elements in the PSTN exchange information over a digital signaling network to effect wireless (cellular) and wireline call setup, routing, and control. Similarly, for calls using VoIP, a session initiation protocol (SIP) may be used to establish and terminate a VoIP call session. The SIP also has the ability to pass both a call identifier and an originating switch identifier.

Alternatively or additionally, other information may be transmitted to the telephone advertising application and/or the call status data may be generated (e.g., at least in part based on data from existing telephone network(s) or successor network(s)) by an application (e.g., the telephone advertising application) in communication with the existing and/or successor network(s). The design of such an application, which may include suitable hardware, software, or both, will be apparent to one of ordinary skill in the art based on the description herein and therefore will not be further described.

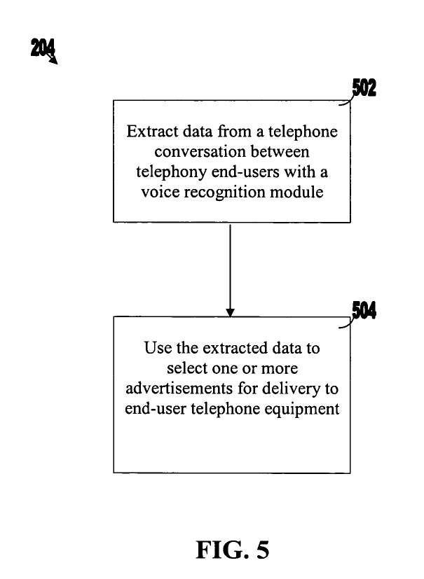

FIG. 5 is a flowchart of illustrative substages involved in stage 204 (FIG. 2) of selecting an advertisement based on data indicative of the personal interests and/or other characteristics of one or more telephony end-users (e.g., three telephony end-users for a 3-way telephone call). At stage 502, data is extracted from a telephone conversation between telephony end-users with a voice recognition module. For example, the voice recognition module may compare the voicestream(s) of one or more of the telephony end-users to a library of spoken words with known meaning, in order to formulate a list of keyword(s). At stage 504, the extracted data may be used to select one or more advertisements (e.g., about a product, service, or company) for delivery to user telephone equipment. For example, the voice recognition module (or other resource) may search a database of advertisements (e.g., database 110 or 162) based on the keywords. Advertisements stored in the database may be accompanied by associated keyword(s) that can be compared with the extracted data (e.g., associated keywords selected by a provider of the ads database based on ad content or auctioned to ad sponsors similar to the auctioning of keywords by providers of Internet search engines such as Yahoo's Sponsored Search). The search may be performed based on the extracted data alone or in combination with other data (e.g., time and/or date of call and/or caller characteristics such as caller telephone number(s), location(s), service provider(s), demographic(s), preference(s), frequency, length, timing of calls, as well as locations and parties called by the caller previously and/or from which the caller received calls). Alternatively or additionally, the extracted data may be used to establish and/or update one or more end-user profiles for the caller(s). Such profiles may be used to select an ad for delivery to user equipment at any suitable time (e.g., the ringing period of a subsequent telephone call or immediately upon completion of a current telephone call such as via a follow-on call when, for example, no ad opportunities become available during the current call).

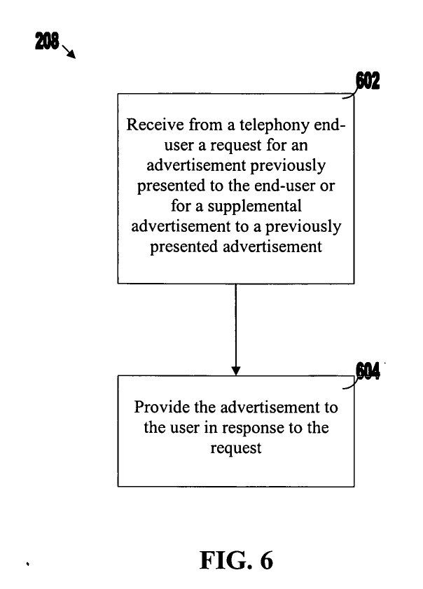

FIG. 6 is a flowchart of illustrative substages involved in stage 208 (FIG. 2) of providing a telephony end-user with interactive functionality with respect to an ad. At stage 602, a request for an advertisement previously presented (in whole or in part) to the end-user or for an ad that supplements a previously presented advertisement may be received from the telephony end-user. For example, the user may press on a telephone keypad or speak “2*” in order to request the advertisement. At stage 602, the advertisement may be provided to the end-user (e.g., immediately, upon completion of a current telephone call, or at a subsequent hold time). In other embodiments related to providing telephony end-users with interactive functionality, a telephony end-user may be provided with the option to press or speak “5*” (or some other suitable option) in order to communicate with a sponsor of an advertisement. For example, upon selecting the option, the end-user may be provided with opportunities to connect to the ad sponsor via telephone immediately or upon the completion of the current call and/or to receive materials from the sponsor via e-mail, physical mail, or by a follow-up telephone call from a representative of the sponsor, at the option of the end-user. Based on the user selection, the ad sponsor may be provided with information regarding the request for information from the end-user, such as the end-user's e-mail address (which may be stored in a user profile accessible by a telephone advertising application). In another embodiment, interactive functionality with respect to informational messages other than ad(s) may be provided to telephony end-users (e.g., by the telephone advertising application or other application). For example, a telephony end-user may be provided with an option to press or speak “3*” at a suitable time (e.g., during a call hold time, during a dial tone or ringing period, during a call such that all parties to the call can hear the message(s)) in order to obtain sports score(s) and/or other informational message(s) that may be of interest to the end-user (e.g., the interests of the end-user being determined based on a stored profile for the end-user).

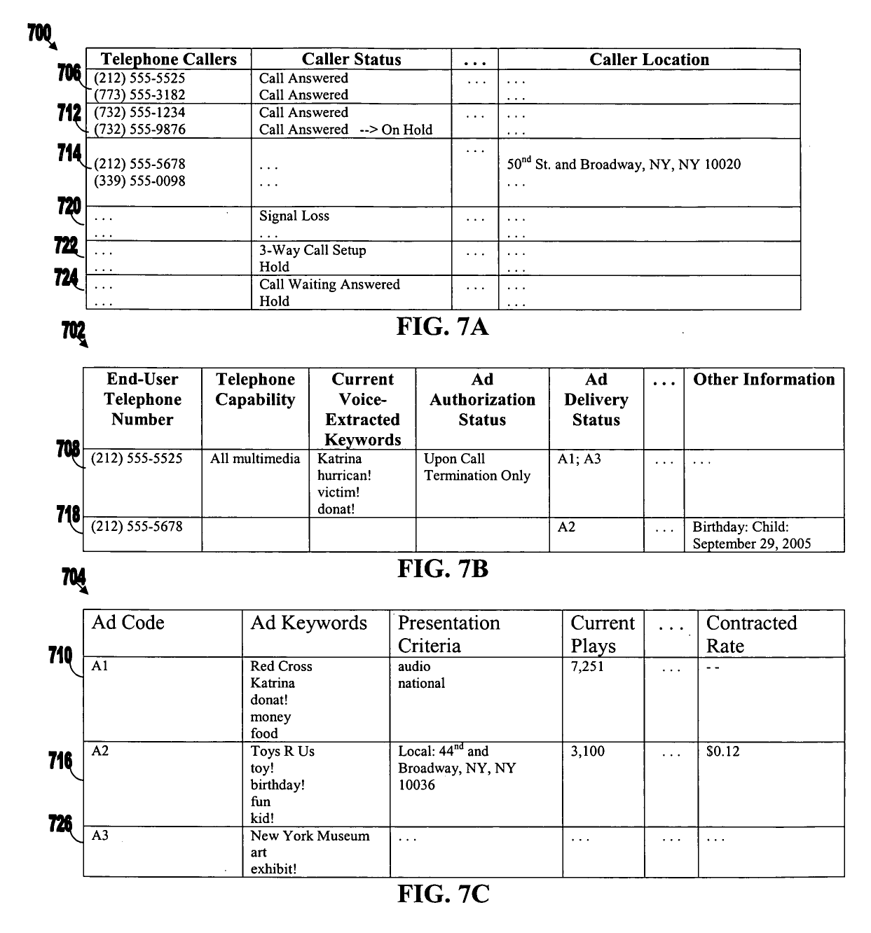

FIGS. 7A-7C show data that may be generated and/or utilized by a telephone advertising application in connection with providing advertising features to telephony end-users in accordance with various embodiments of the present invention. For example, at least a portion of the data in FIGS. 7A-7C may be generated by one or more telephone networks (e.g., data indicating the status of user telephone equipment such as “off-hook”) and then used (e.g., referenced or imported) by the telephone advertising application. As another example, at least a portion of the data may be generated by the telephone advertising application itself (e.g., keywords extracted from telephone conversations of telephony end-users by a voice recognition module). Some or all of the data shown in FIGS. 7A-7C may be stored in, for example, ads database 110 or 162 (FIGS. 1A and 1B), call information memory 112, and/or other memory accessible by the telephone advertising application (e.g., memory located on server 160). The data in FIGS. 7A-7C is shown as being stored in data fields of various tables, in which correlations between data fields (e.g., data fields of the same table or from different tables) may be provided, for example, through the use of pointers or other suitable approach(es). For example, some of the data of a given table may be included in one database, whereas other data shown in the same table may be included in another database. Other approaches for storing and/or correlating the data will be apparent to one of ordinary skill in the art and therefore will not be further described herein.

FIG. 7A shows a table 700 that includes data fields for call status data, including data fields for telephone numbers of parties to a given telephone call, status of the parties with respect to the call, and caller location.

FIG. 7B shows a table 702 that includes data fields for data indicative of the personal interests and/or other characteristics (e.g., preferences) of telephony end-users, including data fields for telephone number of telephony end-user, phone capabilities, current voice-extracted keywords, authorization status with respect to receiving telephony ads, status of ad delivery, and other end-user information (e.g., demographics, interests, other characteristics, important dates, past keywords).

FIG. 7C shows a table 704 that includes data fields for attribute data of advertisements, including data fields for advertisement content (e.g., genre, keywords), advertisement presentation criteria (e.g., type(s) of multimedia, geographical area(s) for distribution), current plays, and contracted rate (e.g., rate-per-play).

The generation and use of the data shown in FIGS. 7A-7C by a telephone advertising application is further described in connection with the following examples illustrative of various embodiments of the present invention. In one example, 2 or more parties that are not sponsors of advertising messages (e.g., two friends) have established a telephone call. This may cause table 700 to include data entry 706 indicating the telephone numbers for the two callers (e.g., (212) 555-5525 and (773) 555-3182) and the call status for both callers (e.g., “call answered”). The voice recognition module may extract from the callers' telephone conversation (e.g., from one or both callers' voicestreams) data indicating that their conversation deals, at least in part, with hurricane Katrina and more particularly to donating to the victims of hurricane Katrina. This detection may be based on words extracted from the conversation by the voice recognition module such as “Katrina”, “hurrican!”, “donat!”, and “victim!”, where “!” is a root expander representing that all variations of the same word are treated as the same word (e.g., in connection with determining the frequency of usage of words during the conversation). These keywords may be stored in entry 708 of table 702 as current voice-extracted keywords. Entry 708 may be a profile for a party to the call and may be indexed by that caller's telephone number. In this example, no user profile may be available for the other party to the call because, for example, the other party may be associated with another telephone advertising application or no telephone advertising application at all. Based on the keywords in data entry 708 (e.g., and/or based on other data such as demographic data or preferences stored as “other information” in entry 708), an advertisement may be selected for presentation to one or both of the callers during a suitable time period such as immediately following the call.

When the call is terminated due to one or both of the callers hanging up their phone, the caller status in entry 706 may change to “call terminated” or “on-hook” and/or entry 706 may be removed from table 700 altogether (e.g., deleted from memory). The type of advertising (e.g., text, video, image, audio, etc.) and whether ads are even provided to the callers may be selected based on, at least in part, the telephone capability and ad authorization status of one or both of the callers. For example, data entry 708 indicates that the associated user telephone equipment can accept all multimedia and that ads are authorized for delivery to the end-user only upon call termination. Thus, a telephone advertising application may search a database of ads based on the keywords and/or other data in entry 708, and may return an advertisement indexed as ad “A1” in entry 710 of table 704 as being a most relevant ad. Particularly, the keywords “Red Cross”, “Katrina”, “donat!”, “money”, and “food” in entry 710 may have produced the best match to the keywords and/or other data from entry 708. Entry 710 may also indicate that the ad is an audio ad to be presented nationally, which may agree with the preferences and/or characteristics of the caller(s) set forth in entry 708. As a result, the telephone advertising application may deliver the selected ad for presentation to the caller(s) upon termination of the call. Subsequent to delivery and/or presentation of the ad, the “Current Plays” data field of entry 710 may be incremented to reflect, for example, the total number of times the ad has been delivered and/or presented to end-users to date (“7,251” in this example). Such a number may be used in connection with the data indicated by the “Contracted Rate” field (free or “—” in this example) to determine the cost of the advertising to the ad sponsor (e.g., Cost per month=Current Plays (determined at the end of the month)*Contracted Rate). “Ad delivery status” in entry 708 also may be incremented or updated to reflect that ad A1 was presented to the end-user. Tracking the ad(s) delivered and/or presented to an end-user may allow, for example, a provider of the end-user's telephone service to adjust the end-user's bill for the service based on the extent to which the end-user is presented with ads. Profile 708 may be used for the targeting of future ad(s), such as by selling data from profile 708 and/or other profile data to third parties for delivery of ads via the physical mail. Alternatively or additionally, the contracted rate may be adjusted based on certain characteristics of the call and/or callers. For example, a higher rate may be charged for presentation or delivery of an ad to a user having certain demographic characteristics (e.g., a telephone number registered in a high-income neighborhood).

In another example related to the generation and use of data in connection with a voice recognition module, when at least one party to a telephone call is a sponsor of an advertising message, keywords extracted by the voice recognition software may be used to select ad(s) sponsored by the at least one party (e.g., and only the at least one party). For example, when a party calls Home Depot (a message sponsor), entry 712 in table 700 may include data indicating that the telephone numbers for the two callers are (732) 555-1234 and (732) 555-9876) where the former telephone number is for Home Depot. Entry 712 may also indicate that the status for both callers is currently “call answered.” The voice recognition module may extract the keyword “hardware” from the callers' telephone conversation (e.g., when the caller has requested to be transferred to the “hardware” section or a Home Depot employee states that the “hardware” section is an appropriate destination for the caller's inquiry). If the party is then placed on hold (e.g., for transfer to the hardware section), this status change may be indicated in entry 712. Upon detecting this status change, a telephone advertising application may search a database of ads for an ad that is sponsored by Home Depot and that is associated with the keyword “hardware” (e.g., an advertisement regarding current promotions on hardware products by Home Depot), for immediate delivery and presentation to the party. The telephone advertising application may store a list of Home Depot telephone numbers (e.g., a list of all Home Depot stores across the United States) in order to allow this procedure to be used whenever a party calls any Home Depot throughout the United States. A variation on this example would include selecting and presenting an advertisement for a competitor of Home Depot (e.g., Lowe's) whenever a party calls any Home Depot (e.g., the search of the ads database being performed for ads sponsored by Lowe's instead of Home Depot).

Thus, in this example, even if the parties' telephone conversation indicates that the parties would be good candidates for ads from other sponsor(s) (e.g., the party and the Home Depot employee having engaged in conversation regarding Hurricane Katrina, which would indicate a good match with the above-described ad sponsored by the Red Cross), the ads of other sponsor(s) (e.g., an image ad for Lowe's or the Red Cross) may not be presented as a result of the call. Alternatively, the ads of the other sponsors may be suppressed during the call, but may be presented to user telephone equipment upon completion of the call or at another suitable time period with respect to a call (e.g., the ringing period of a subsequent call). Such image ads may be set automatically as wallpaper on the user equipment. Alternatively or additionally, such ads may be presented (e.g., updated) with any suitable frequency or schedule (e.g., hourly, weekly, daily, in response to a change in the user's profile, at times specified by agreements with message sponsors) such as, for example, at times that are not linked to timeframes of a call. The ad(s) may be delivered through the user of a dedicated transmission to a particular installation of user telephone equipment, or broadcast to multiple installations of user telephone equipment (e.g., end-users who have similar profile data). To illustrate this point, a picture ad including the Wendy's logo and the phrase “Eat Great, Even Late!” may be delivered to and displayed at 11 p.m. on all user telephone equipment for which the telephone advertising application has the associated telephone number (e.g., and for which the application has accessed data indicating that end-user(s) associated with the equipment have keywords “Wendy's” or “McDonald's” stored in their respective profile(s).

In still another example related to the generation and use of data in connection with a voice recognition module, ad(s) are transmitted to user telephone equipment based on data regarding two or more callers (“multi-modal” advertising). For example, an end-user of a mobile telephone having telephone number (212) 555-5678 may be engaged in a telephone call with an end-user of a land-line telephone having telephone number (339) 555-0098, as reflected by entry 714 in table 700. Based on the keywords “birthday” and “toy” extracted from the voicestream of the latter caller, and based on location information in entry 714 indicating that the former caller (i.e., the mobile end-user) is located in “50^{th} St. and Broadway, NY, NY 10020” (e.g., location information provided by Global Positioning System (GPS) technology), the telephone advertising application may select ad “A2” sponsored by Toys R Us (entry 716 in table 704) for presentation to one or both of the end-users. Particularly, entry 716 may include data indicating that ad A2 is associated with keywords “toy!” and “birthday!” (as well as keywords “Toys R Us,” “fun,” and “kid!” not extracted during the telephone conversation by the voice recognition module) and that the ad sponsor is located at “44^{th} and Broadway, NY, NY 10036” in geographic proximity to the mobile end-user. Entry 716 may also include data indicating that ad A2 has received 3,111 plays to date at a contracted rate of $0.12 per play. In another embodiment (e.g., in which no voice recognition module is used), the same advertisement could be selected for presentation to the mobile end-user based on the data in the end-user's profile 718 indicating that a child associated with the end-user has a birthday in the near future. Such information may be furnished by the end-user to a provider of the telephone advertising application (e.g., via a questionnaire). In still another embodiment, the telephone advertising application may select, deliver, and/or present ad(s) to a first party to a telephone call based on information regarding a second party to the call. For example, for a telephone call involving an individual from New York and a flower shop in Chicago, ad(s) (e.g., ad(s) for 1-800-flowers, balloons, commercial airline flights, etc.) may be presented to the New York individual based on profile data for the flower shop indicating that, for example, the telephone line being used by the caller from Chicago is registered to a flower shop.

In other examples, the data in tables 700, 702, and 704 may be generated and/or used in connection with advertising to end-users during various timeframes. For example, table 700 may include data entry 720 indicating that at least one party to a call (e.g., a three-way call) has experienced signal loss. Detection of this data in entry 720 may cause the telephone advertising application to deliver ad(s) to the remaining parties to the call until the at least one party rejoins the call. As another example, data entry 722 may include data indicating that at least one party to a call has been placed on hold so that another party can set up a 3-way call, where the party setting up the 3-way call has initiated but has not completed dialing of the telephone number for the third party. In response to detecting this data, the telephone advertising application may deliver ad(s) to the party placed on hold during the hold time for 3-way call setup. In still another example, data entry 724 may include data indicating that at least one party to a call has been placed on hold so that another party can answer call waiting. In response to detecting this data in entry 724, the telephone advertising application may deliver ad(s) (e.g., ad(s) based on voice recognition keywords and/or other data) to the party placed on hold during the hold time. In another example, a telephone call currently in progress (e.g., a telephone call involving end-user(s) who have paid a reduced fee for their telephone service) may be interrupted by ad(s) selected, delivered, and/or presented by the telephone advertising application (e.g., the ad(s) preceded by a tone or other indicator that the ads will be presented). The parties to the telephone call may be prevented from communicating with one another until presentation of the ad(s) is complete. As indicated by the various ellipses in tables 700, 702, and 704, these tables may include various other data generated or used in connection with providing advertising features to telephony end-users in accordance with various embodiments of the present invention.

In other examples, multiple advertisements may be presented to telephony end-users. For example, multiple ads may be presented one after another during the same advertising timeframe (e.g., during a hold time for three-way call setup, when the hold time exceeds the length of a first advertisement presented to telephony end-user(s)). As another example, a first one or more ads may be presented during a first timeframe, and a second one or more ad(s) may be presented during a second timeframe. To illustrate this point, in the above example relating to presenting ad A1 710 regarding hurricane Katrina to caller(s) upon completion of the call, one or more of the caller(s) may also be presented with an advertisement prior to completion of the call (e.g., a dial-tone ad, an ad presented during the ringing period, an ad presented during call waiting or 3-way call setup hold). For example, the voice recognition module may determine that an initial portion of the telephone conversation relates to “art” “exhibits,” such as a portion of the conversation that occurs prior to the discussion of hurricane Katrina. The telephone advertising application may also determine that one of the callers is from New York (e.g., based on a determination that area code “212” listed in data entry 706 is a New York area code). In response, the telephone advertising application may cause ad A3 726 for a New York museum with art exhibits to be presented to the New York caller when the New York caller is placed on hold by the caller having the “773” area code. After the hold time, the telephone conversation may turn to hurricane Katrina, which may cause ad A1 710 to be presented to the caller(s) upon completion of the call.

Thus it is seen that systems and methods are provided for advertising to telephony end-users. Although particular embodiments have been disclosed herein in detail, this has-been done by way of example for purposes of illustration only, and is not intended to be limiting with respect to the scope of the appended claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other, unclaimed inventions are also contemplated. The inventors reserve the right to pursue such inventions in later claims.

Insofar as embodiments of the invention described above are implementable, at least in part, using a computer system, it will be appreciated that a computer program for implementing at least part of the described methods and/or the described systems is envisaged as an aspect of the present invention. The computer system may be any suitable apparatus, system or device. For example, the computer system may be a programmable data processing apparatus, a general purpose computer, a Digital Signal Processor or a microprocessor. The computer program may be embodied as source code and undergo compilation for implementation on a computer, or may be embodied as object code, for example.

It is also conceivable that some or all of the functionality ascribed to the computer program or computer system aforementioned may be implemented in hardware, for example by means of one or more application specific integrated circuits.

Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk (CD) or a digital versatile disk (DVD), or magnetic memory such as disc or tape, and the computer system can utilize the program to configure it for operation. The computer program may also be supplied from a remote source embodied in a carrier medium such as an electronic signal, including a radio frequency carrier wave or an optical carrier wave.

What is claimed is:

1. A method of initiating advertising to end-user telephone equipment, said method comprising:
determining a status of a telephone call; and
initiating, based on said determining and by a party other than the part(ies) to said telephone call, advertising to said end-user telephone equipment during a timeframe selected from the group of timeframes consisting of a dial-tone period of said telephone call, telephone signal loss by a party to said telephone call, a ringing period of said telephone call during which said advertising is initiated to a called party as a ring tone, a call-waiting hold time of said telephone call, and three-way call setup of said telephone call.

2. The method of claim 1, wherein:
said determining comprises determining that said end-user telephone equipment is off-hook; and
said initiating advertising comprises initiating advertising to said end-user telephone equipment during said dial-tone period.

3. The method of claim 1, wherein:
said determining comprises determining that said party to said telephone call has experienced said telephone signal loss; and
said initiating advertising comprises initiating advertising to said end-user telephone equipment during said signal loss.

4. The method of claim 3, further comprising discontinuing said advertising as a result of said party rejoining said telephone call.

5. The method of claim 1, wherein:
said determining comprises determining that said telephone call is in said ringing period; and
said initiating advertising comprises initiating advertising to said end-user telephone equipment during said ringing period as said ring tone.

6. The method of claim 1, wherein:
said determining comprises determining that said end-user telephone equipment has been placed on hold to allow another party to said telephone call to answer call waiting; and
said initiating advertising comprises initiating advertising to said end-user telephone equipment during said call-waiting hold time.

7. The method of claim 6, further comprising discontinuing said advertising when said another party rejoins said telephone call.

8. The method of claim 1, wherein:
said determining comprises determining that said user telephone equipment has been placed on hold to allow another party to said telephone call to set up a three-way call; and
said initiating advertising comprises initiating advertising to said end-user telephone equipment during said three-way call setup.

9. The method of claim 8, further comprising discontinuing said advertising when said another party rejoins said telephone call.

10. The method of claim 1, wherein said initiating advertising to said end-user telephone equipment comprises:
causing one or more advertisements to be delivered to said end-user telephone equipment; and
causing one or more of said advertisements to be presented to said end-user telephone equipment.

11. The method of claim 1, wherein said initiating advertising comprises initiating an advertisement comprising audio, text, image, video, or a combination thereof.

12. The method of claim 1, wherein said initiating advertising comprises selecting said advertising based on a voicestream from a telephone call involving said end-user telephone equipment.

13. Apparatus for initiating advertising to end-user telephone equipment, said apparatus comprising:
a telephone advertising application under at least the primary control of a party other than the parties to a telephone call, said telephone advertising application configured to:
determine the status of said telephone call; and
initiate, based on said determining, advertising to said end-user telephone equipment during a timeframe selected from the group of timeframes consisting of a dial-tone period of said telephone call, telephone signal loss by a party to said telephone call, a ringing period of said telephone call during which said advertising is initiated to a called party as a ring tone, a call-waiting hold time of said telephone call, and three-way call setup of said telephone call.

14. The apparatus of claim 13, wherein said telephone advertising application is configured to:
determine that said end-user telephone equipment is off-hook; and
initiate advertising to said end-user telephone equipment during said dial-tone period.

15. The apparatus of claim 13, wherein said telephone advertising application is configured to:
said determining comprises determining that said party to said telephone call has experienced said telephone signal loss; and
said initiating advertising comprises initiating advertising to said end-user telephone equipment during said signal loss.

16. The apparatus of claim 15, wherein said telephone advertising application is further configured to discontinue said advertising as a result of said party rejoining said telephone call.

17. The apparatus of claim 13, wherein said telephone advertising application is configured to:
determine that said telephone call is in said ringing period; and
initiate advertising to said end-user telephone equipment during said ringing period as said ring tone.

18. The apparatus of claim 13, wherein said telephone advertising application is configured to:
determine that said end-user telephone equipment has been placed on hold to allow another party to said telephone call to answer call waiting; and
initiate advertising to said end-user telephone equipment during said call-waiting hold time.

19. The apparatus of claim 18, wherein said telephone advertising application is further configured to discontinue said advertising when said another party rejoins said telephone call.

20. The apparatus of claim 13, wherein said telephone advertising application is configured to:
determine that said user telephone equipment has been placed on hold to allow another party to said telephone call to set up a three-way call; and
initiate advertising to said end-user telephone equipment during said three-way call setup.

21. The apparatus of claim 20, wherein said telephone advertising application is further configured to discontinue said advertising when said another party rejoins said telephone call.

22. The apparatus of claim 13, wherein said telephone advertising application is configured to:
cause one or more advertisements to be delivered to said end-user telephone equipment; and
cause one or more of said advertisements to be presented to said end-user telephone equipment.

23. The apparatus of claim 13, wherein said advertising comprises an advertisement comprising audio, text, image, video, or a combination thereof.

24. The apparatus of claim 13, wherein said telephone advertising application is configured to select said advertising based on a voicestream from a telephone call involving said end-user telephone equipment.

25. Apparatus for initiating advertising to end-user telephone equipment, said apparatus comprising:
means for determining a status of a telephone call; and
means for initiating, based on said determining and by a party other than the part(ies) to said telephone call, advertising to said end-user telephone equipment during a timeframe selected from the group of timeframes consisting of a dial-tone period of said telephone call, telephone signal loss by a party to said telephone call, a ringing period of said telephone call during which said advertising is initiated to a called party as a ring tone, a call-waiting hold time of said telephone call, and three-way call setup of said telephone call.

26. A method of selecting an advertisement for delivery to end-user telephone equipment, said method comprising:
selecting said advertisement for delivery to said end-user telephone equipment based on a voicestream of a telephony end-user.

27. The method of claim 26, further comprising extracting said data from said voicestream by a voice recognition module.

28. The method of claim 27, wherein said extracting data comprises extracting keywords from said voicestream.

29. The method of claim 27, wherein said extracting said data comprises extracting said data from voicestreams of at least two telephony end-users while said at least two telephony end-users are party to the same telephone call.

30. The method of claim 26, wherein said selecting said advertisement comprises selecting said advertisement based on at least one additional criterion.

31. The method of claim 30, wherein said at least one additional criterion comprises a criterion from a profile.

32. The method of claim 26, wherein said advertisement comprises audio.

33. The method of claim 26, wherein said advertisement comprises at least one of an image, video, and text.

34. The method of claim 26, further comprising initiating said advertisement to said end-user telephone equipment during a timeframe.

35. The method of claim 34, wherein said initiating said advertisement during a timeframe comprises initiating said advertisement during a timeframe selected from the group of timeframes consisting of a dial tone period, a ringing period and involving a ring tone, a ringing period and involving a ringback signal, a busy signal period, a call hold time and immediately upon completion of a call.

36. The method of claim 34, wherein said initiating said advertisement during a timeframe comprises initiating said advertisement during a timeframe that is not based on the status of any telephone call.

37. The method of claim 34, further comprising providing an end-user of said end-user telephone equipment with an interactive feature with respect to said advertisement.

38. A method of selecting advertising for delivery to end-user telephone equipment, said method comprising:
determining caller information for first, second, and third parties to the telephone call; and
based on said caller information, selecting an advertisement for delivery to end-user telephone equipment of at least one of said parties.

39. A method of advertising to end-user telephone equipment, said method comprising:
causing delivery of an image advertisement to said end-user telephone equipment; and
causing said advertisement to be set as wallpaper on a display of said end-user telephone equipment.

40. The method of claim 39, wherein said causing delivery of said image advertisement comprises selecting said image advertisement based on a profile associated with said end-user telephone equipment.

41. The method of claim 39, wherein said causing said image advertisement to be set as wallpaper on said display of said end-user telephone equipment comprises causing said image advertisement to be set as wallpaper on said display automatically subsequent to said delivery.

42. The method of claim 39, wherein said causing said image advertisement to be set as wallpaper on said display of said end-user telephone equipment comprises causing a prompt to be presented to an end-user associated with said end-user telephone equipment, wherein a response to said prompt from said end-user causes said image advertisement to be set as wallpaper on said display.

43. A method of providing an end-user of end-user telephone equipment with interactive functionality with respect to an advertisement, said method comprising:
causing delivery of a first advertisement to said end-user telephone equipment; and
in response to receiving a selection of an option from said end-user, causing delivery of a second advertisement to said end-user telephone equipment, wherein said second advertisement is related to said first advertisement.

44. The method of claim 43, wherein said first advertisement and said second advertisement are the same advertisement.

45. The method of claim 43, wherein said second advertisement is an enhanced version of said first advertisement.
